(19) United States
(12) Patent Application Publication
(10) Pub. No.: US 2024/0179028 A1
(43) Pub. Date: May 30, 2024

(54) CLOUD-BASED VIRTUAL EXTENSABLE LOCAL AREA NETWORK (VXLAN) TUNNEL SWITCHING ACROSS ACCESS POINTS

(71) Applicant: Fortinet, Inc., Sunnyvale, CA (US)

(72) Inventors: Songbo Wang, Saratoga, CA (US); Yong Zhang, Belmont, CA (US)

(73) Assignee: Fortinet, Inc., Sunnyvale, CA (US)

(21) Appl. No.: 18/072,230

(22) Filed: Nov. 30, 2022

(51) Int. Cl. H04L 12/46

(52) U.S. Cl. CPC H04L 12/4679; H04L 12/4633

(57) ABSTRACT

VXLAN tunnels are configured between a VXLAN tunnel server and each of the plurality of access points using a VXLAN profile. Tunnel groups are formed between the access point and the plurality of access points. Each tunnel group defines interconnections between VXLAN tunnels such that each tunnel in a group is able to exchange packets securely. A data packet is switched between a first VXLAN tunnel coupled to the first access point on the first LAN and a second VXLAN tunnel coupled to the second access point on the second LAN, based on a VLAN ID stored within of the data packet. The data packet is transmitted to the second station through the second access point on the second LAN over the second VXLAN.

### FIELD OF THE INVENTION

The invention relates generally to computer security, and more specifically, for cloud-based virtual extensible local access network (VXLAN) tunnel switching for a plurality of access points from a cloud-based interface.

### BACKGROUND

Generally, VXLAN tunnels are a virtual overlay generated for secure communications between different clients over a physical overlay of large cloud computing deployments, such as data centers. VXLAN resolves VLANs inability to be routed as an encapsulation tool by providing data center connectivity using tunneling to stretch layer 2 connections over an underlying layer 3 network. An encryption such as IPSec is applied to data packets sent through the tunnels. VXAN is officially documented by the Internet Engineering Task Force (IETF) in Request for Comments (RFC) 7348, the contents of which are hereby incorporated by reference.

When VXLANs extend across different LANs, a point-to-point topology of VXLAN tunnels is created between the two or more access points. As the number of different LANs in communication increases, the number (N) of point-to-point tunnels increases non-linearly (i.e., N*(N−1) tunnels). As a result, at a certain point, the overhead of administering different tunnels can put a strain on the network devices involved. In turn, network performance deteriorates.

Therefore, what is needed is a robust technique for configuring and managing VXLAN tunnels for a plurality of access points from a cloud-based interface.

### SUMMARY

These shortcomings are addressed by the present disclosure of methods, computer program products, and systems for configuring and managing VXLAN tunnels for a plurality of access points from an access controller.

In one embodiment, VXLAN tunnels are configured between a VXLAN tunnel server and each of the plurality of access points using a VXLAN profile. Tunnel groups are formed between the access point and the plurality of access points. Each tunnel group defines interconnections between VXLAN tunnels such that each tunnel in a group is able to exchange packets securely.

In another embodiment, a data packet is received in real-time from a first station on a first LAN through the first access point and destined for a second station on a second LAN through the second access point, within one of the tunnel groups. Subsequent data packets from the same flow session are received periodically until the session is complete. The data packet is switched between a first VXLAN tunnel coupled to the first access point on the first LAN and a second VXLAN tunnel coupled to the second access point on the second LAN, based on a VLAN ID stored within of the data packet. The data packet is transmitted to the second station through the second access point on the second LAN over the second VXLAN.

Advantageously, computer device performance, and also network performance, are both improved with more efficient administration of VXLAN tunnels.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a block diagram illustrating a system for configuring and managing VXLAN tunnels for a plurality of access points, according to an embodiment.

FIG. 2 is a more detailed block diagram illustrating an access controller of the system of FIG. 1, according to an embodiment.

FIG. 3A is a block diagram illustrating a data packet with fields related to VXLAN administration, according to an embodiment.

FIG. 3B is a block diagram illustrating a data path of the data packet over the system of FIG. 1, according to an embodiment.

FIG. 4 is a high-level flow diagram illustrating a method for central administration of VXLAN communication across LANs, according to an embodiment.

FIG. 5A is a more detailed flow diagram illustrating a step for configuring VXLAN tunnel switching, from the method of FIG. 4, according to one preferred embodiment.

FIG. 5B is a more detailed flow diagram illustrating a step for managing VXLAN tunnel switching, from the method of FIG. 4, according to one preferred embodiment.

FIG. 6 is a high-level block diagram illustrating a computing device as an example hardware implementation of network devices herein, according to an embodiment.

### DETAILED DESCRIPTION

The description below provides methods, computer program products, and systems for configuring and managing VXLAN tunnels for a plurality of access points. One of ordinary skill in the art will recognize many additional variations made possible by the succinct description of techniques below.

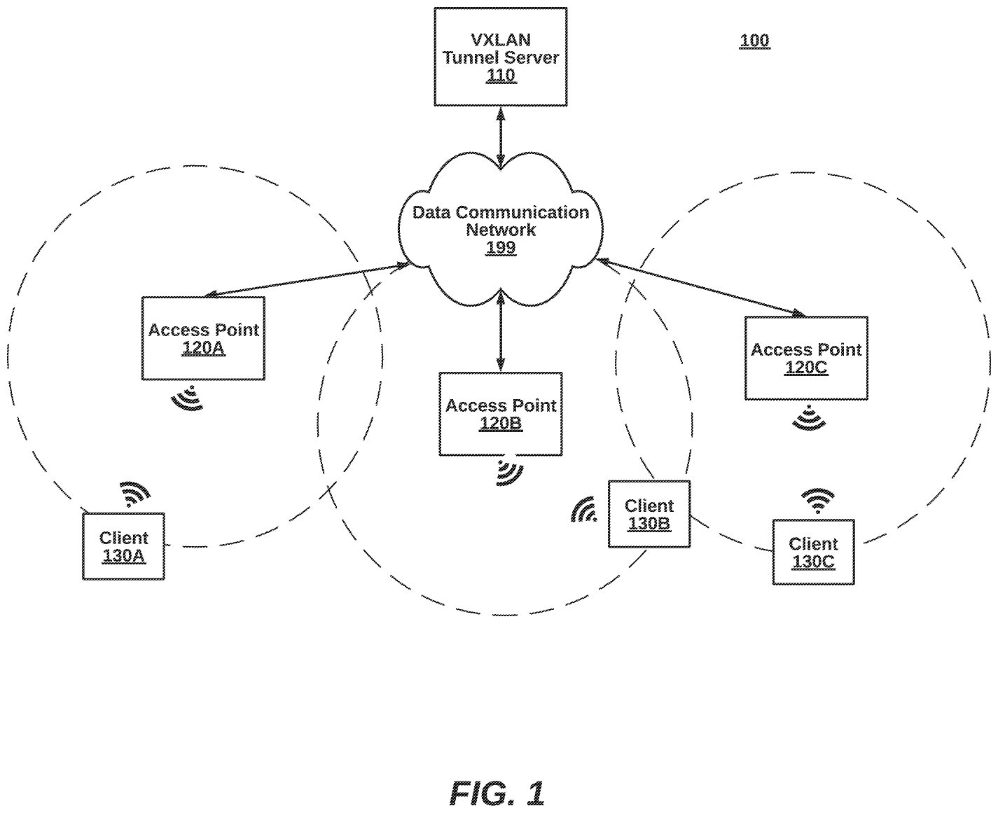

### I. Systems for VXLAN Tunnel Switching (FIGS. 1-3)

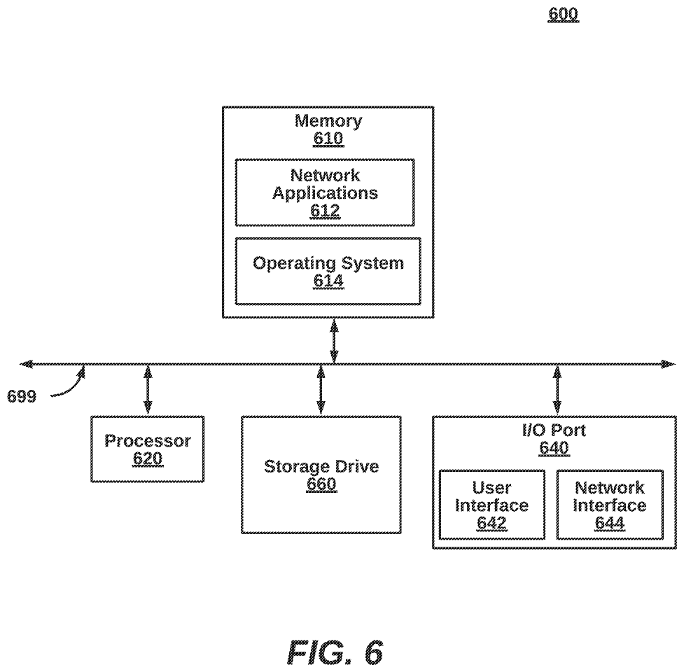

FIG. 1 is a block diagram illustrating a system 100 for configuring and managing VXLAN tunnels for a plurality of access points, according to an embodiment. The system 100 includes a VXLAN tunnel server 110, a DHCP server 115 access points 120A,B,C, and clients 130A,B,C, each coupled to a data communication network 199. Many other configurations are possible, for example, with additional network components such routers, switches, repeaters, firewalls, and the like. Also, there can be many more or fewer network gateways in FIG. 1. The system components can be implemented in computer devices with non-transitory source code, such as set forth below with reference to FIG. 6.

The components of the system 100 are coupled in communication over the data communication network 199, in various manners. The components can be connected to the data communication system via hard wire (e.g., VXLAN tunnel server 110, DHCP server 115 and access point 120A,B,C) or wirelessly (e.g., clients 130A,B,C). The client 130A wirelessly connects to the access point 120A for access to the data communication network 199, as does the client 130B through the access point 120B and the client 130C through the access point 130A. The data communication network 199 can be any data communication network such as an SDWAN, an SDN (Software Defined Network), WAN, a LAN, WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, and the like.

The VXLAN tunnel server 110 sets up a switching interface between VXLAN tunnels to each of the access points 120A,B,C using VXLAN profiles. Data packets can be multicast in the control plane to manage multiple VTEPs. To set up, the VXLAN tunnel server 110 discovers access points and a CAP/WAP session is established between the devices. VTEP are set up on both the VXLAN tunnel server 110 and access points using parameters sent to access points. Each access point can connect a different LAN (e.g., Beijing office, London office and San Francisco office). A VXLAN profile provides high level configuration for each LAN. Accordingly, connections are made between the VXLAN tunnel server 110 and each of the access points 120A,B,C, and a VXLAN tunnel is constructed. The DHCP server 115 assigns IP addresses. A switching fabric is configured to connect VXLAN tunnels according to the VXLAN profile. In operation, real-time network traffic between LANs is sent upstream on a VXLAN tunnel to the VXLAN tunnel server 110, where the traffic is switched and sent downstream on a VXLAN tunnel towards its destination. VXLAN tunnels can be deleted through a message sent through the CAP/WAP session to access points.

The VXLAN profile, in an embodiment, can include three parameters: P1 for VNI-GROUP-ID to define VXLAN group number between 1 and 15; P2 for server_underlay_interface to define underlay of bind interfaces to VXLAN tunnels on the server side; and P3 for ac side VXLAN group switch interface DHCP server IP address and netmask.

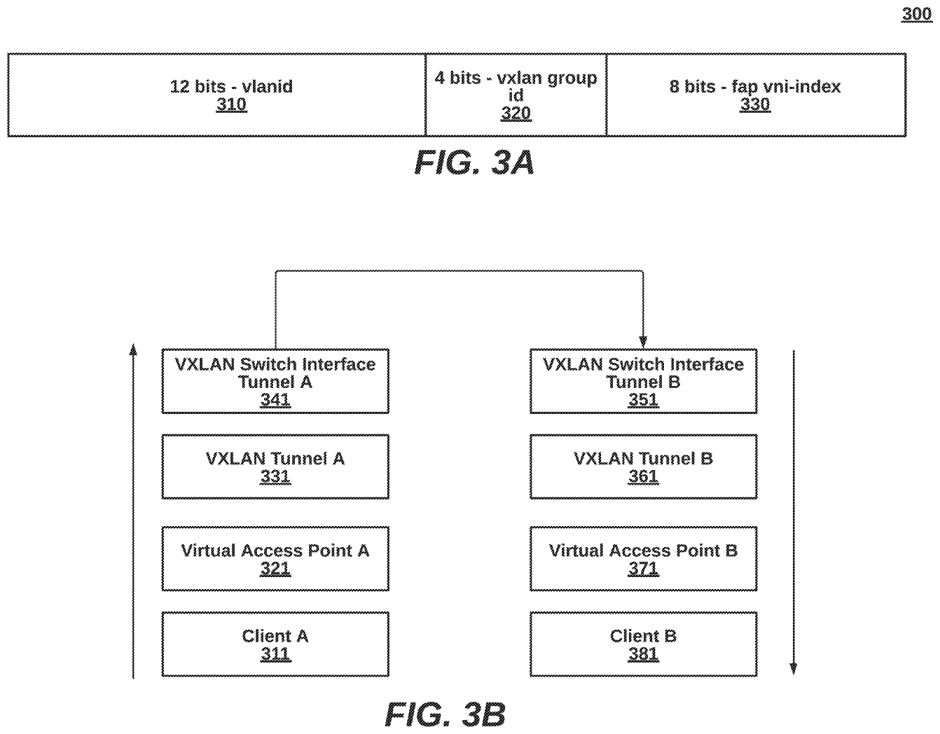

Data packets are formatted for routing through tunnels, as shown in FIG. 3A. Accordingly, there is a VLANID field of 12 bits, a VXLAN group ID field of 4 bits and a FAP VNI-index field of 8 bits. The VLANID field specifies which VXLAN tunnel will accommodate in the local VLAN bridge. For example, if the VLANID is 100, the VXLAN tunnel will create in an access point under bridge, br.100. The VXLAN group ID field define a VXLAN tunnel group used by the VXLAN tunnel server 110. The FAP VNI-index field is uniquely assigned to each access point at boot up.

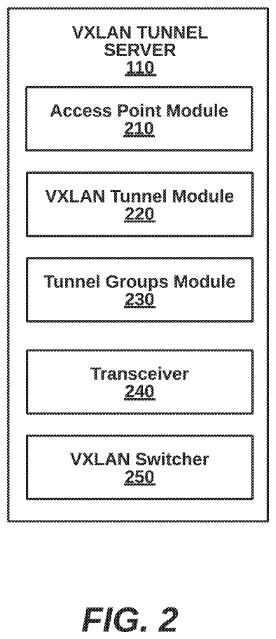

The VXLAN tunnel server 110 is described in more detail with respect to FIG. 2.

The access points 120A,B,C connect with the VXLAN tunnel server 110 to offload peer-to-peer VXLAN connections with each other. In general, the access points 120A,B,C authenticates and associates with the clients 130A,B,C using an SSID. Once connected, stations can exchange general data packets across the data communication network 199. A separate interface for securing packet exchange connects to a VXLAN tunnel connected to the VXLAN tunnel server 110. In one embodiment, the access points 120A,B,C create additional VXLAN tunnels separate from the VXLAN tunnel server 110, for direct connections to other access points or for a second connected VXLAN tunnel server.

Data packets received by the access points 120A,B,C wirelessly from clients are retransmitted over wire to the VXLAN tunnel server 110 for processing. Non-tunnel traffic between LANs can also be handled by the access points 120A,B,C. In one embodiment, the access points 120A,B,C download an operating system patch, a daemon or application for interoperation with the VXLAN tunnel server 110.

The clients 130A,B,C exchange data packets with each other across LANs through switching by the VXLAN tunnel server 110. To initiate an access point connection, clients receive beacons broadcast from access points within RF range and select an SSID corresponding to a chosen access point. Responsive to a DHCP request packet, an IP address is assigned to each client from the DHCP server 115 of VXLAN tunnel group switch interface. A ping from a transmitting client can be via a ICMP request packet to a receiving client. Standard data packets for tunneling are then transmitted by clients, in an embodiment, as configured with fields according to FIG. 3A. Non-tunneled data packets can use standard wireless protocols without VLAN field values. In one embodiment, the process described herein is transparent to the clients 130A,B,C and no modification to devices is necessary. In another embodiment, an operating system patch or browser application patch, for example, can be modified for deeper integration of processes.

FIG. 2 is a more detailed block diagram illustrating a network gateway device of the system of FIG. 1, according to an embodiment. The network gateway device 110 includes an access point module 210, a VXLAN tunnel module 220, a tunnel groups module 230, a transceiver 240, and a VXLAN switcher 250. The modules can be implemented in source code stored in non-transitory memory executed by a processor. Alternatively, the modules can be implemented in hardware with microcode. The modules can be singular or representative of functionality spread over multiple components. Many other variations are possible.

The access point profiles module 210 can receive a VXLAN profile from each of the plurality of access points. Updates can be processed and result in configuration changes.

The VXLAN tunnel module 220 configures a VXLAN tunnel between the access controller and each of the plurality of access points using the VXLAN profile. Each VXLAN tunnel has a unique VXLAN ID. A VTEP on an interface for the server side connects to a VTEP on an interface on the access point side.

The tunnel groups module 230 can form tunnel groups between the plurality of access points. Each tunnel group defines interconnections between VXLAN tunnels. A user over a graphical user interface, a network administrator, or an automated process can determine which LANs will have virtualization capabilities between clients, as part of a VXLAN profile. Examples of groups associated with tunnel groups include, without limitation, an accounting department, a security department, guests, executives, office locations, and the like.

The transceiver 240 receives a data packet in real-time from a first station on a VTEP from a first VXLAN tunnel of the first access point and destined for a second station on a second LAN through the second access point, within one of the tunnel groups. The transceiver 240 transmits the data packet to the second station through a VTEP to the second access point on the second LAN over the second VXLAN tunnel. As such, a transmitter and receiver can be dedicated for each access point connection or hardware can be shared for different connections. In operation, digital data bits for the VXLAN data packets are transformed to analog signals sent over a channel medium to a terminating transceiver at an access point.

The VXLAN tunnel switcher 250 switches as a VXLAN proxy, on a second layer, data packets between a first VXLAN tunnel coupled to the first access point on the first LAN and a second VXLAN tunnel coupled to the second access point on the second LAN. Switching is in the control plane to different VTEPs based on a VLAN ID stored within of the data packets. Each tunnel group can be separately configured for switching. For example, access points 120A and 120C may form a switching group without access point 120B. Similarly, access points 120A and 120B may form a switching group without granting permission to 120C. The VXLAN tunnels can terminate on the server and access point sides with VXLAN tunnel endpoints (VTEPs) which are responsible for encapsulation and decapsulation.

A VXLAN remote IP address can be configured as a public multicast IP address for aggregating each access point. Each VTEP runs a multicast protocol such as PIM in the control plane based on layer 3 routing. Security policies can control switching. In one implementation, the VXLAN tunnel switcher 250 is communicatively coupled to forward data packets to the transceiver 240 for transmission of data packets.

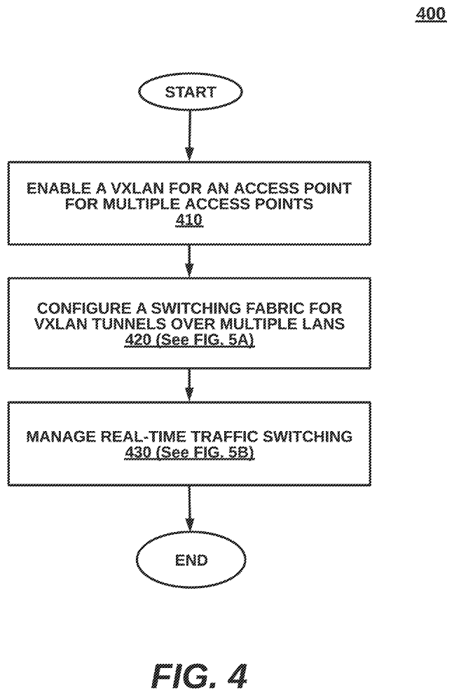

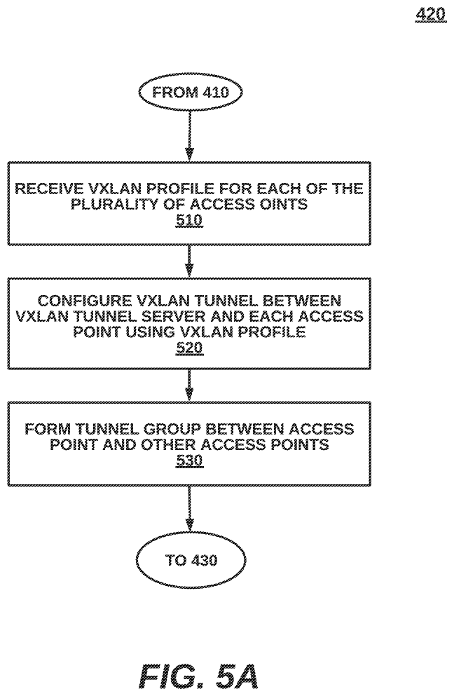

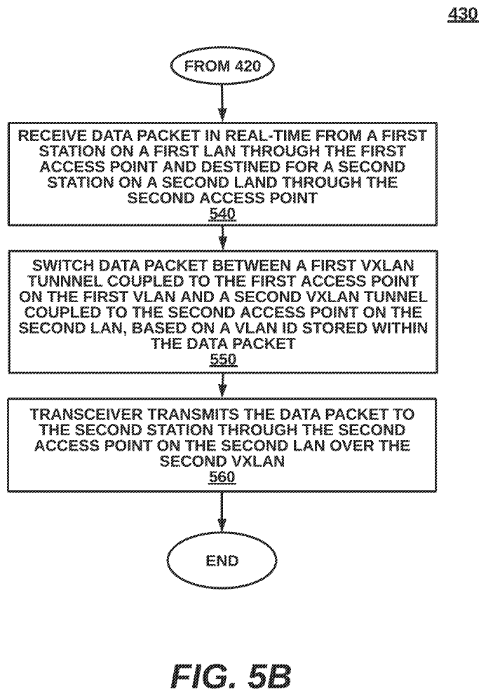

### III. Methods for VXLAN Tunnel Switching (FIGS. 4-5)

FIG. 4 is a high-level flow diagram illustrating a method 400 for central administration of VXLAN communication across LANs, according to one preferred embodiment. The method 400 can be implemented, for example, by the VXLAN tunnel server 110 of the system 100. The steps are merely representative groupings of functionality, as there can be more or fewer steps, and the steps can be performed in different orders. Many other variations of the method 400 are possible.

At step 410, a VXLAN mode is enabled for an access point. In response, a switching fabric for VXLAN tunnels over multiple LANs is configured at step 420, as described in FIG. 5A. At step 430, real-time traffic switching is managed, as described in FIG. 5B. The method 400 continues until the VXLAN mode is disabled for the access point.

FIG. 5A is a more detailed flow diagram illustrating a step 420 for configuring VXLAN tunnel switching, from the method 400 of FIG. 4, according to one preferred embodiment.

At step 510, a VXLAN profile for each of the plurality of access points is received. At step 520, a VXLAN tunnel is configured between the VXLAN tunnel server and each of the plurality of access points using the VXLAN profile. Each VXLAN tunnel has a unique VXLAN ID. At step 530, tunnel groups are formed between the access point and the plurality of access points. Each tunnel group defines interconnections between VXLAN tunnels such that each tunnel in a group is able to exchange packets securely.

FIG. 5B is a more detailed flow diagram illustrating a step 430 for managing VXLAN tunnel switching, from the method 400 of FIG. 4, according to one preferred embodiment.

At step 540, a data packet is received in real-time from a first station on a first LAN through the first access point and destined for a second station on a second LAN through the second access point, within one of the tunnel groups. Subsequent data packets from the same flow session are received periodically until the session is complete.

At step 550, a data packet is switched between a first VXLAN tunnel coupled to the first access point on the first LAN and a second VXLAN tunnel coupled to the second access point on the second LAN, based on a VLAN ID stored within of the data packet.

At step 560, a transceiver transmits the data packet to the second station through the second access point on the second LAN over the second VXLAN.

### V. Computing Environment for VXLAN Tunnel Switching (FIG. 6)

FIG. 6 is a block diagram illustrating a computing device 600 capable of implementing components of the system 100 for VXLAN tunnel switching, according to an embodiment. The computing device 600 of the present embodiment, includes a memory 610, a processor 620, a storage drive 630, and an I/O port 640. Each of the components is coupled for electronic communication via a bus 699. Communication can be digital and/or analog and use any suitable protocol. The computing device 600 can be any of components of the system 100, other networking devices (e.g., the VXLAN tunnel server 110, the access points 120A,B,C, the clients 130A,B,C, a firewall device, a gateway, or a router), or a disconnected device.

Network applications 612 (e.g., VM nodes 120A-F) can be network browsers, daemons communicating with other network devices, network protocol software, and the like. An operating system 614 within the computing device 600 executes software, processes. Standard components of the real OS environment 614 include an API module, a process list, a hardware information module, a firmware information module, and a file system. The operating system 614 can be FORTIOS, one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The storage drive 630 can be any non-volatile type of storage such as a magnetic disc, EEPROM (electronically erasable programmable read-only memory), Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g., an RF antennae) connects to a medium such as Ethernet or Wi-Fi for data input and output. Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer ⅔ routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A computer-implemented method in a cloud-based VXLAN tunnel server for switching virtual extensible local access network (VXLAN) tunnels between a plurality of access points, wherein at least two of the access points are located on different LANs, the method comprising:
receiving a VXLAN profile from each of the plurality of access points;
configuring a VXLAN tunnel between the access controller and each of the plurality of access points using the VXLAN profile, wherein each VXLAN tunnel has a unique VXLAN ID;
forming tunnel groups between the plurality of access points, wherein each tunnel group defines interconnections between VXLAN tunnels;
receiving a data packet in real-time from a first station on a first LAN through the first access point and destined for a second station on a second LAN through the second access point, within one of the tunnel groups;
switching, on a second layer, a data packet between a first VXLAN tunnel coupled to the first access poit on the first LAN and a second VXLAN tunnel coupled to the second access point on the second LAN, based on a VLAN ID stored within of the data packet; and
transmitting the data packet to the second station through the second access point on the second LAN over the second VXLAN.

2. A non-transitory computer-readable media storing source code in a VXLAN tunnel server that, when executed by a processor, performs a method for distributing security report generation over multiple levels of a security fabric, the method comprising the steps of:
receiving a VXLAN profile from each of the plurality of access points;
configuring a VXLAN tunnel between the access controller and each of the plurality of access points using the VXLAN profile, wherein each VXLAN tunnel has a unique VXLAN ID;
forming tunnel groups between the plurality of access points, wherein each tunnel group defines interconnections between VXLAN tunnels;
receiving a data packet in real-time from a first station on a first LAN through the first access point and destined for a second station on a second LAN through the second access point, within one of the tunnel groups;
switching, on a second layer, a data packet between a first VXLAN tunnel coupled to the first access poit on the first LAN and a second VXLAN tunnel coupled to the second access point on the second LAN, based on a VLAN ID stored within of the data packet; and
transmitting the data packet to the second station through the second access point on the second LAN over the second VXLAN.

3. A VXLAN tunnel server for distributing security report generation over multiple levels of a security fabric, the network gateway device comprising:
a processor;
a network interface, communicatively coupled to the processor and to a data communication network; and
a memory, communicatively coupled to the processor and comprising:
receiving a VXLAN profile from each of the plurality of access points;
configuring a VXLAN tunnel between the access controller and each of the plurality of access points using the VXLAN profile, wherein each VXLAN tunnel has a unique VXLAN ID;
a first module to form tunnel groups between the plurality of access points, wherein each tunnel group defines interconnections between VXLAN tunnels;
a second module to receive a data packet in real-time from a first station on a first LAN through the first access point and destined for a second station on a second LAN through the second access point, within one of the tunnel groups;
a third module to switch, on a second layer, a data packet between a first VXLAN tunnel coupled to the first access point on the first LAN and a second VXLAN tunnel coupled to the second access point on the second LAN, based on a VLAN ID stored within of the data packet; and
a fourth module to transmit the data packet to the second station through the second access point on the second LAN over the second VXLAN.
